(19) United States
(12) Patent Application Publication
(10) Pub. No.: US 2006/0029883 A1
(43) Pub. Date: Feb. 9, 2006

(54) Photosensitive resin bag for non-pre-sensitized printing plate making

(76) Inventor: Hilson Huang, Taipei (TW)

Correspondence Address: Hilson Huang, P.O. Box 44 - 2049, Taipei, 10668, TW

(21) Appl. No.: 11/195,596

(22) Filed: Aug. 3, 2005

(30) Foreign Application Priority Data
Aug. 5, 2004 (TW) 093212479

(51) Int. Cl. G03C 1/76

(52) U.S. Cl. 430/270.1

(57) ABSTRACT

A photosensitive resin bag used for the non-pre-sensitized printing plate making process comprises a transparent outer bag containing the liquid photosensitive resin. The liquid photosensitive resin is filled into the body of the thin bag with no air bubble. Furthermore, the quantity of the liquid photosensitive resin is limited by the volume of the photosensitive resin bag which is set to form an even and proper thickness photosensitive resin coating as the bag is pressed flat by two transparent clipping glasses. This formed photosensitive resin coating is used as a printing plate for printing after the process is completed.

### BACKGROUND OF THE INVENTION

1. Field of the Invention

This invention relates to a photosensitive resin bag used for the non-pre-sensitized printing plate making process which is a flat thin transparent bag with a certain volume of liquid photosensitive resin. This bag could be pressed flat by being placed directly between two transparent clipping glasses during the non-pre-sensitized printing plate making process. Therefore, the liquid photosensitive resin can form an even and proper thickness coating which composes a printing plate. And liquid photosensitive resin also can isolate the negative film for protection and reuse. This invention can replace the prior process of pouring a certain quantity of the liquid photosensitive resin from a can container into a preset close frame to form a liquid coating used as a printing plate base by a set of thickness gauge.

2. Description of the Prior Art

The prior methods of reproducing a printing plate from a negative A1 are the pre-sensitized plate making process and the non-pre-sensitized plate making process. The pre-sensitized plate making process uses a formed resin plate as the printing plate base to reproduce a printing plate A2 with the same image of the negative A1 through the exposure and washout procedure. The non-pre-sensitized plate making process instead of the formed resin plate with the liquid photosensitive resin as the element material produces the printing plate A2 (FIG. 2) by means of performing the forming and exposure procedure simultaneously first then the washout procedure to complete the plate for printing.

Furthermore, the prior non-pre-sensitized plate making process must work with an exposure system. Before performing the forming and exposure procedure, there are some steps has been done first. Referring to the FIG. 1, a drawer A3 used for the exposure procedure is opened from the exposure system and contains clipping planks consisted of an upper transparent glass A4 and a lower transparent glass A5. And there is an air-extracting apparatus set between these two glasses. Lifting the upper glass A4 first, putting the negative A1 on the top of the lower glass A5, and setting four thickness posts A6 at the four sides of the area. Afterward it is necessary to lay a covering film A7 over the tops of the negative A1 for protecting the negative A1 by isolating it from the liquid photosensitive resin.

A close frame A8 is set around the edge of the negative A1 as thickness gauge depends on the thickness of the printing plate and is filled with the liquid photosensitive resin which is pouring from a can container. But the pouring quantity of the liquid photosensitive resin must be controlled properly and produce no bubble. If there is any bubble in it, have to be eliminated. Then, it forms an even coating A9 with proper thickness. A plastic film (such as polyester) is covered on the surface of the photosensitive coating A9 as a base film A10. The plastic film has to be covered from the center of the coating A9, it can avoid forming any bubble between them again. Afterward the upper glass A4 is covered back and is clipped tightly with the lower glass A5 to form the assembly shown as the FIG. 1. The drawer A3 is pushed back into the exposure system for performing the exposure procedure. A light source A1 1 is illuminated from the bottom. After completing the exposure, we can see the rough images from the negative on the printing plate A2 which is the partial hardened part of the photosensitive resin A9 attached with the base film A10, which is stuck together to prevent the shrinkage during printing. Finally, the printing plate A2 attached the base film A10 shown as the FIG. 2 is formed after completing the washout procedure with solvent or water.

The pouring quantity of the liquid photosensitive resin into the close frame A8 for forming the coating A9 must be controlled precisely, it requires a highly skilled operator with sufficient experience to perform this activity. Or the quality of the printing plate A2 can not be ensured. And also after the exposure procedure, the liquid photosensitive resin of the opaque area is still unhardened but the liquid photosensitive resin is set openly during the above manufacturing process; it is uneasy to be collected and becomes a hinder of the recycle and environment protection.

### SUMMARY OF THE INVENTION

This invention provides a photosensitive resin bag used for non-pre-sensitized printing plate making process which comprises a flat transparent bag containing a proper quantity of the photosensitive resin inside. It is fixed flat by two clipping glasses to become a photosensitive structure coating used as the base of a printing plate. The liquid photosensitive resin can isolate the negative for protection and stick with the other side of bag as a dimension stable base film to support the printing plate preventing of shrinkage during printing. This invention can simplify and accelerate the plate making process by replacing the prior activity of presetting a close frame then pouring the precise quantity of the liquid photosensitive resin into it to form a photosensitive resin coating then take off the bubbles. And this invention can make the recycle of the unhardened liquid photosensitive resin easier that makes contributions to the environment protection.

The size of this invention can match up with the negative or any printing plate size from small to big such as A5˜A0 etc of any commercial paper size with very even thickness with a tolerance of ±0.03 mm. It is very easy for the printing factory to select and use. So it achieves the manufacturing purpose of the mass-production and the standardization.

This invention can provide an easy recycle method by cutting an opening on any side of the bag for pouring out again the non-sensitized non-hardened liquid resin after the exposure procedure. It achieves the purpose of protecting the environment.

This invention can allow using a special treated plastic film (such as polyester) as the material of the bag to form a base film of printing plate. After removing the outer bag as completing the exposure procedure of the liquid photosensitive resin, the formed printing plate bottom will stick firmly with the base film after exposure. It could also avoid the procedure of covering a base film of the prior manufacturing activity from requiring experienced skill and occurring bubble.

This invention can be also clipped into a matching size transparent case to form a kit which is installed and sealed into an opaque package. It achieves not only the purpose of easy transporting and stocking before using but also as easy as contacting a negative inside the transparent case for exposure procedure immediately.

### BRIEF DESCRIPTION OF THE DRAWINGS

FIG. 1 is a cutaway perspective view of a prior liquid photosensitive resin placing structure before the exposure procedure of a non-pre-sensitized plate making process;

FIG. 2 is a cutaway perspective view of a printing plate of the FIG. 1;

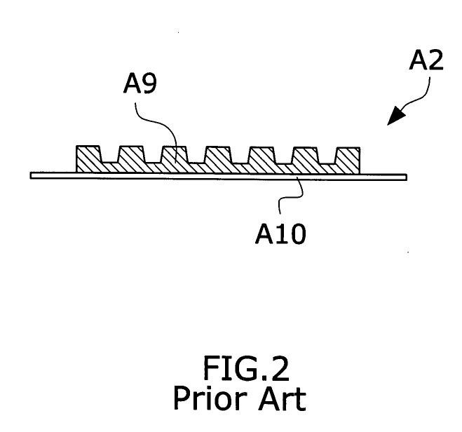

FIG. 3 is a system perspective view of a preferred embodiment of the present invention;

FIG. 4 is a cutaway perspective view of the preferred embodiment of FIG. 3;

FIG. 5 illustrates a cutaway perspective view of the preferred embodiment of FIG. 3 in an operating position;

FIG. 6 illustrates a cutaway perspective view of the second preferred embodiment of the present invention;

FIG. 7 illustrates the system perspective view of the preferred embodiment of the set which consists of the present invention and the transparent case as a ready to operate kit;

FIG. 8 illustrates the system perspective view of the kit of FIG. 7 stored in an opaque package.

### DESCRIPTION OF THE PREFERRED EMBODIMENTS

This invention comprises an outer bag 10 containing proper quantity of liquid photosensitive resin 20.

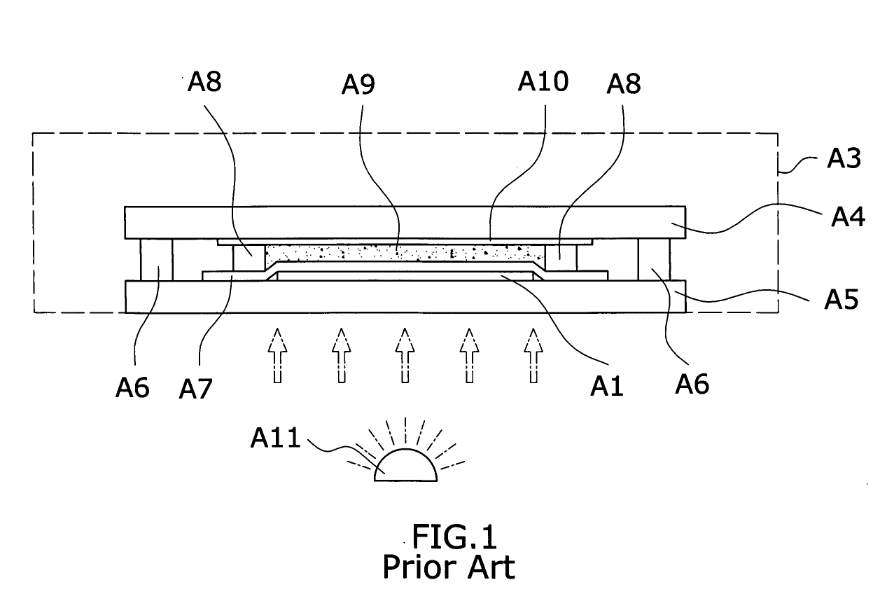

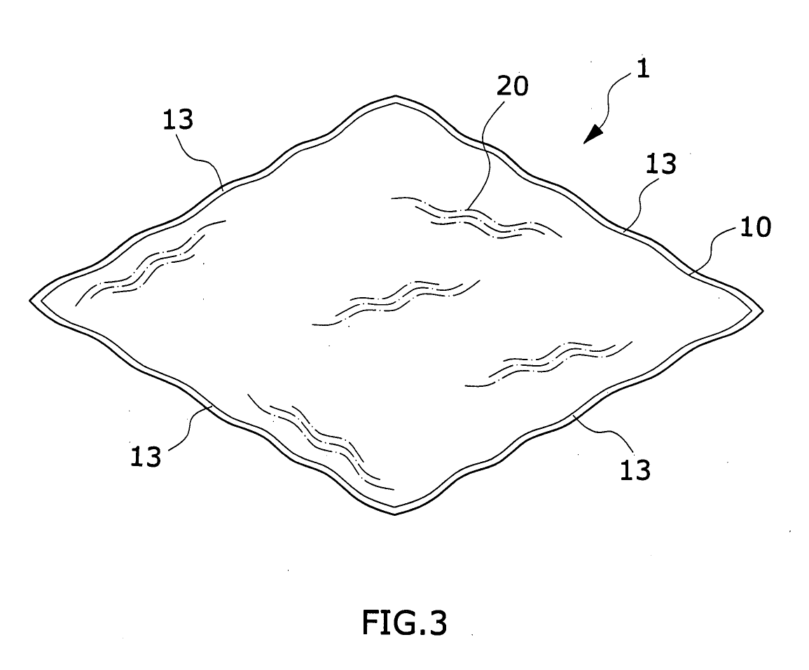

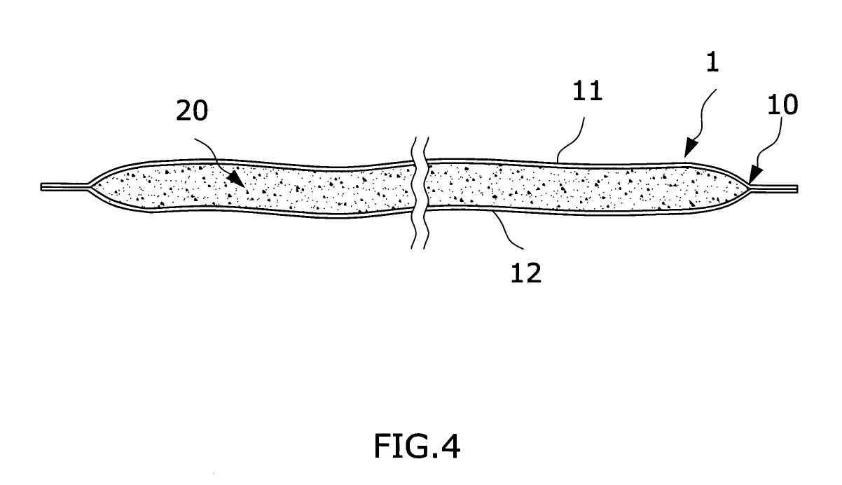

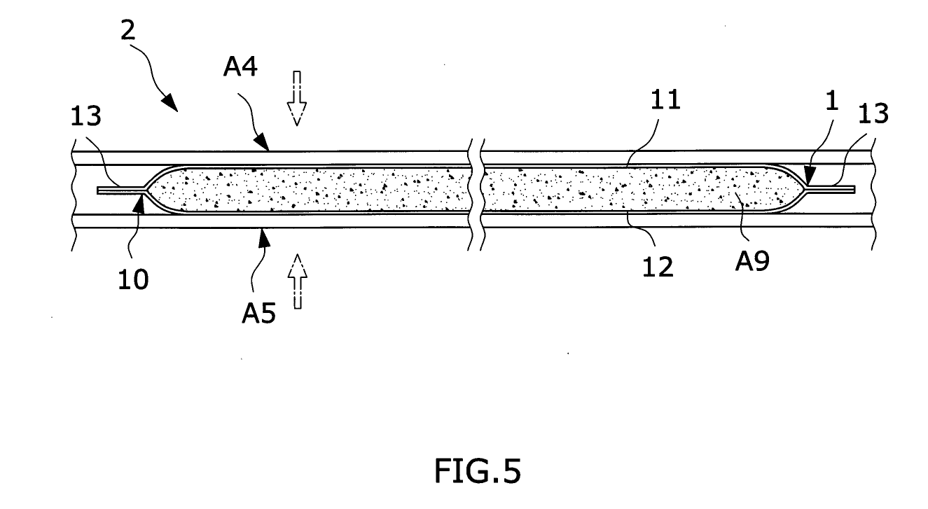

Referring to the FIGS. 3, 4 and 5, a photosensitive resin bag 1 used for the non-pre-sensitized printing plate making process comprises an outer bag 10 containing liquid photosensitive resin 20 inside. The outer bag 10 is flat and its soft material doesn't react chemically with the photosensitive resin 20. The outer bag 10 contains two symmetrical planes 11 and at least one plane 1 1 is transparent as a light-pervious plane 12 for penetrating lights into the outer bag 10 to irradiate the liquid photosensitive resin 20. The outer bag 10 is formed by two transparent plastic membranes with a sealing line 13 on their outside edges. The shape and size of the outer bag 10 is flexible to allow the light-pervious plane 12 covering all the common range of the negative A1 and is fitting to the manufacturing requirement of the mass-production and the standardization. The light-previous plane 12 covers the used range of the negative A1. And the shape and size of the outer bag 10 is flexible to match any kind of the negative A1 by setting as the commercial paper specification such as A5˜A0 for the printing plate A2 manufacturer's selection easily based on the shape and size of the negative A1 or the printing plate A2. The liquid photosensitive resin 20 is filled into the outer bag 10 with no air bubble. Its features are no bubble existing inside the bag 10 and the filling quantity of the liquid photosensitive resin 20 controlled by the capacity of the outer bag 10. As the two planes 11 of the bag 1 are clipped and pressed flatly into a clipping equipment 2 which is similar to the clipping planks with two transparent glasses A4 and A5 shown as the FIG. 1. Referring to the FIG. 5, the liquid photosensitive resin 20 could form the photosensitive resin coating A9 inside the bag 10 with an even thickness about 0.7 mm˜7.0 mm and tolerance of ±0.03 mm as the required thickness of a formed printing plate A2.

During operation, based on the shape or size of the negative A1 or the printing plate A2, a proper and suitable photosensitive resin bag 1 can be selected and be set into the clipping equipment 2 consisting of two transparent glasses A4 and A5 shown as the FIG. 1. This completes the presetting activity before the exposure procedure. It really avoids a lot of trouble activities of the prior manufacturing processes such as that: it is necessary to lay a covering film A7 shown as the FIG. 1 to separate and protect the negative A1; it is necessary to preset a close frame A8 around the edge of the negative A1; it is necessary to pour the precise quantity of the liquid photosensitive resin 20 into the close frame A8 and take off all the bubbles; and it is necessary to wait the liquid photosensitive resin 20 to form the evenly thick photosensitive resin coating A9; . . . etc. This invention really achieves the purpose of simplifying and accelerating the whole process.

After the completion of the exposure procedure, light penetrates the photosensitive resin bag 1 to harden the liquid resin 20 for forming the photosensitive resin coating A9 to be a printing plate A2. Before washout the printing plate A2 by removing the outer bag 10, it only needs to cut an opening on one side of outer bag 10 to pour out the rest of the un-exposed un-hardened liquid photosensitive resin 20. This invention allows easily recycle the liquid photosensitive resin 20 than the prior non-pre-sensitized plate making process and do improve the efficiency of environment protection.

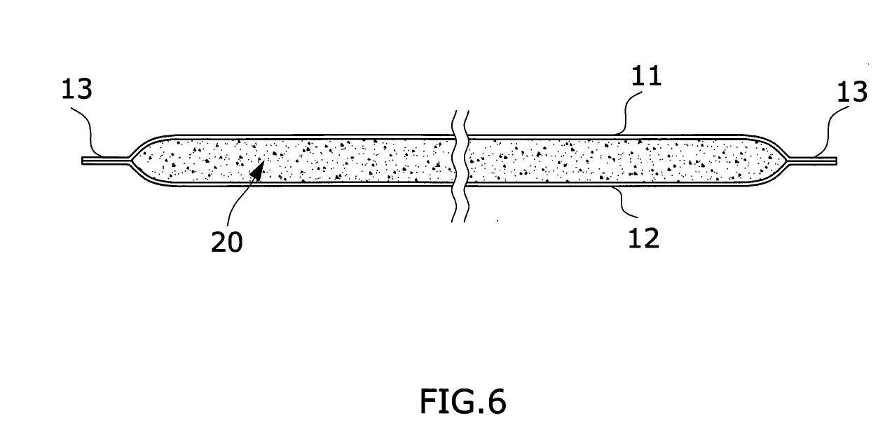

Referring to the FIG. 6, some hollow images without linking together might be on the printing plate A2, hence it is normally necessary to set a base film A10 to carry the whole printing plate A2. This invention considers this operation requirement; a plane 11 formed by polyester material treated specially could be used as the plane of the outer bag 10. which is opposite plane 11 of the light-pervious plane 12 of the outer bag 10. Then, the liquid photosensitive resin 20 is filled in with no air bubble. After completing the exposure procedure and removing the outer bag 10, the plane 11 is stuck on the bottom of the formed printing plate A2 and is used as the base film of the printing plate A2.

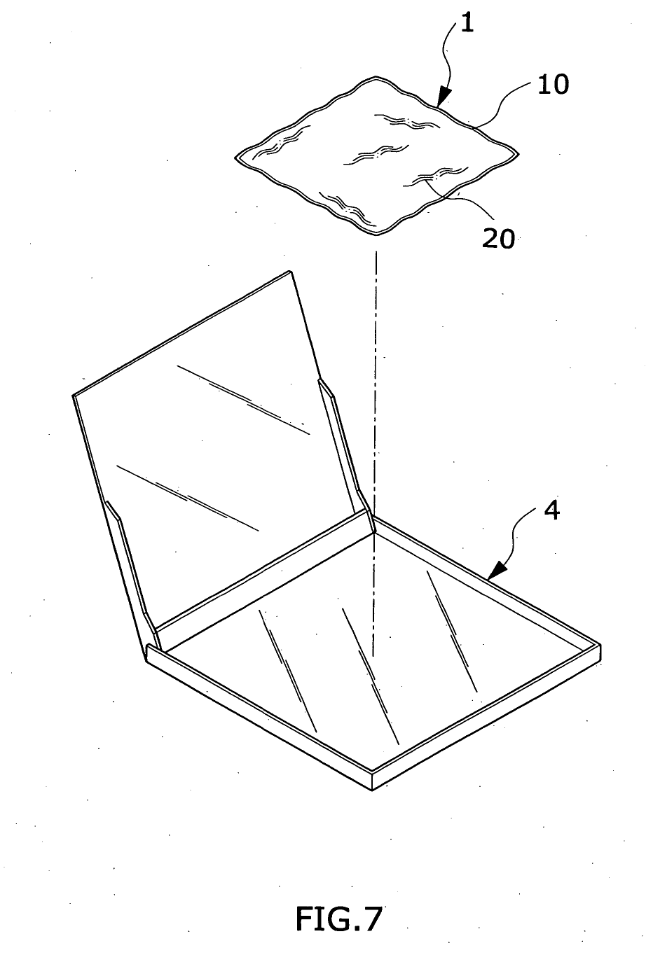

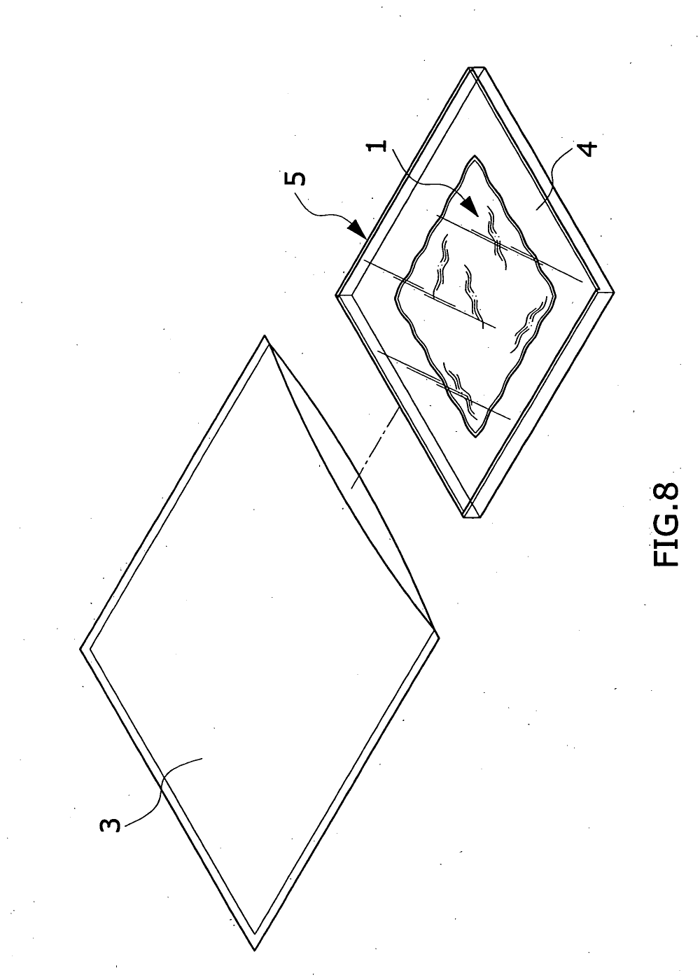

Referring to the FIGS. 7 and 8, the liquid photosensitive resin 20 will be hardened as illuminating by lights, so it is necessary to be stored in an opaque can container and is poured out as using. This invention considering this feature creates the photosensitive resin bag 1 as a single-bag package style. It can be wrapped and sealed by an opaque package bag 3, or be installed into a transparent case 4 with matching size to become a kit 5 then the kit 5 is wrapped by the opaque package 3. It is very easy for handling, storing and transporting. And the transparent case 4 can be also treated as the clipping equipment 2 to clip the photosensitive resin bag 1 which is similar to the clipping planks consisted of two transparent glasses A4 and A5 which is shown as the FIG. 1. The kit 5 can be put into the drawer A3 of the exposure system directly without setting another separate pair of the clipping planks consisted of two transparent glasses A4 and A5. Obviously the invention is susceptible to changes or alternations without defeating its practicability. Therefore, the preferred embodiment shown in the drawings and described herein is not confined.

What is claimed is:

1. A photosensitive resin bag used for non-pre-sensitized printing plate making process comprising:
an outer bag with two planes and with soft material only one plane is chemically stabilized with liquid photosensitive resin;
a light-pervious plane set at least one of said planes of said outer bag;
said outer bag containing liquid photosensitive resin inside to isolate a negative,
said liquid photosensitive resin forming a photosensitive resin coating inside said outer bag as said planes of said outer bag being clipped flat and being illuminated,
the quantity of said liquid photosensitive resin being controlled by the volume of said outer bag;
said photosensitive resin coating forming a printing plate by means of putting said light-previous plane of said outer bag on the top of said negative through the exposure procedure of the non-pre-sensitized printing plate making process.

2. The photosensitive resin bag used for the non-pre-sensitized printing plate making process according to claim 1 and further including:
a sealing line set on the edge of the planes of said outer bag,
said planes being plastic film.

3. The photosensitive resin bag used for the non-pre-sensitized printing plate making process according to claim 1 and further including:
the shape and size of said bag matching the shape and size of said negative;
said light-previous plane covering all range of said negative size from A5 to A0.

4. The photosensitive resin bag used for the non-pre-sensitized printing plate making process according to claim 1 and further including:
the thickness of said photosensitive coating set as the required thickness of said formed printing plate from 0.7 to 7.0 mm with tolerance of ±0.03 mm.

5. The photosensitive resin bag used for the non-pre-sensitized printing plate making process according to claim 1 and further including:
said plane of said outer bag used as a base film of said formed printing plate.

6. The photosensitive resin bag used for the non-pre-sensitized printing plate making process according to claim 1 and further including:
the opposite plane of said light-previous plane to be used as a base film of said formed printing plate.

7. The photosensitive resin bag used for the non-pre-sensitized printing plate making process according to claim 1 and further including:
said photosensitive bag stored and sealed in an opaque package.

8. The photosensitive resin bag used for the non-pre-sensitized printing plate making process according to claim 1 and further including:
a set comprising said photosensitive resin bag clipped flat by a transparent case to make a easy kit, contact with a negative to exposure directly without exposure machine to make a printing plate.

9. The photosensitive resin bag used for the non-pre-sensitized printing plate making process according to claim 8 and further including:
said kit stored and sealed in an opaque package.
